(19) United States
(12) Patent Application Publication
(10) Pub. No.: US 2014/0268557 A1
(43) Pub. Date: Sep. 18, 2014

(54) INFORMATION PROCESSING APPARATUS, ELECTRONIC APPARATUS, AND FRAME UNIT FOR INFORMATION PROCESSING APPARATUS

(71) Applicant: FUJITSU LIMITED, Kawasaki-shi (JP)

(72) Inventors: Masaki Iwata, Kawasaki (JP); Masuo Ohnishi, Hachioji (JP)

(73) Assignee: FUJITSU LIMITED, Kawasaki-shi (JP)

(21) Appl. No.: 14/206,678

(22) Filed: Mar. 12, 2014

(30) Foreign Application Priority Data
Mar. 18, 2013 (JP) 2013-055017

(51) Int. Cl. G06F 1/16

(52) U.S. Cl. CPC G06F 1/1681
USPC 361/679.55

(57) ABSTRACT

An information processing apparatus includes a body, a frame, and a hinge that allows the frame to be attached to a side face of the body in such a manner as to be rotatable and stoppable at any angle.

### CROSS-REFERENCE TO RELATED APPLICATION

This application is based upon and claims the benefit of priority of the prior Japanese Patent Application No. 2013-055017, filed on Mar. 18, 2013, the entire contents of which are incorporated herein by reference.

### FIELD

The embodiment discussed herein is related to an information processing apparatus such as a tablet personal computer, an electronic apparatus, and a frame unit for an information processing apparatus.

### BACKGROUND

In general, an information processing apparatus such as a tablet personal computer has a limited number of input/output interfaces because of it being a tablet. Hence, there is a proposal of a mechanism that allows a tablet personal computer to be attached to another electronic apparatus. Such a technology is disclosed by Japanese Laid-open Patent Publication No. 2005-158013, for example.

It is preferable that a tablet personal computer be easily attachable to another electronic apparatus as well as being usable as a tablet personal computer.

### SUMMARY

According to an aspect of the invention, an information processing apparatus includes a body, a frame, and a hinge that allows the frame to be attached to a side face of the body in such a manner as to be rotatable and stoppable at any angle.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic perspective view of a tablet personal computer according to an embodiment;

FIG. 2 is another schematic perspective view of the tablet personal computer according to the embodiment;

FIG. 3 is an enlarged schematic perspective view of part A illustrated in FIG. 2;

FIG. 4 is yet another schematic perspective view of the tablet personal computer according to the embodiment;

FIG. 5 is yet another schematic perspective view of the tablet personal computer according to the embodiment;

FIG. 6 is a schematic exploded perspective view of the tablet personal computer according to the embodiment;

FIG. 7 is an enlarged schematic exploded perspective view of a part illustrated in FIG. 6;

FIG. 8 is an enlarged schematic perspective view of the part illustrated in FIG. 6 with a hinge and a frame attached to a rear cover;

FIG. 9 is a schematic exploded perspective view illustrating a mechanism of attaching the frame to the rear cover in the embodiment;

FIG. 10 is a schematic perspective view of a base unit according to the embodiment;

FIG. 11 is another schematic perspective view of the base unit according to the embodiment;

FIG. 12 is a schematic bottom view of the base unit according to the embodiment;

FIG. 13 is a schematic plan view of one of fitting members included in the tablet personal computer according to the embodiment;

FIG. 14 is another schematic plan view of the fitting member included in the tablet personal computer according to the embodiment;

FIG. 15 is an enlarged schematic bottom view of part B illustrated in FIG. 12;

FIG. 16 is an enlarged schematic bottom perspective view of the fitting member according to the embodiment;

FIG. 17 is a schematic perspective view illustrating a state where the tablet personal computer according to the embodiment is yet to be attached to the base unit;

FIG. 18 is an enlarged schematic perspective view of a part illustrated in FIG. 17;

FIG. 19 is an enlarged schematic perspective view of another part illustrated in FIG. 17;

FIG. 20 is a schematic perspective view illustrating a state where the tablet personal computer according to the embodiment is yet to be attached to the base unit;

FIG. 21 is a schematic perspective view illustrating a state where the tablet personal computer according to the embodiment has been attached to the base unit;

FIG. 22 is another schematic perspective view illustrating the state where the tablet personal computer according to the embodiment has been attached to the base unit;

FIG. 23 is a schematic perspective view illustrating a state of the tablet personal computer according to the embodiment attached to the base unit;

FIG. 24 is a schematic perspective view illustrating another state of the tablet personal computer according to the embodiment attached to the base unit;

FIG. 25 is a schematic exploded perspective view illustrating a modification of the mechanism of attaching the frame to the rear cover;

FIG. 26 is a schematic exploded perspective view illustrating another modification of the mechanism of attaching the frame to the rear cover;

FIG. 27 is a schematic perspective view illustrating a modification of the tablet personal computer;

FIG. 28 is a schematic perspective view illustrating a modification concerning the tablet personal computer and the base unit, with the tablet personal computer yet to be attached to the base unit; and

FIG. 29 is a schematic perspective view illustrating the modification concerning the tablet personal computer and the base unit, with the tablet personal computer attached to the base unit.

### DESCRIPTION OF EMBODIMENT

Hereinafter, a preferred embodiment of the present disclosure will be described with reference to accompanying drawings.

Referring to FIGS. 1, 2, 4, and 6, a tablet personal computer 1 as an information processing apparatus according to the embodiment includes a tablet (slate)-personal-computer body 10, a frame 14, and hinges 30.

The tablet-personal-computer body 10 has a rectangular parallelpiped shape. The tablet-personal-computer body 10 includes a front face 19a, a rear face 19b provided opposite the front face 19a, and side faces 50. The front face 19a and the rear face 19b are parallel to each other. The side faces 50 include four side faces 51, 52, 53, and 59. The side faces 51, 52, 53, and 59 are perpendicular to the front face 19a and the rear face 19b. The side face 51 and the side face 53 are parallel to each other. The side face 52 and the side face 59 are parallel to each other. The side faces 51 and 53 are perpendicular to the side faces 52 and 59. The side faces 50 of the tablet-personal-computer body 10 are provided with external connection terminals (not illustrated) to which Universal-Serial-Bus (USB) connectors are to be connected, an earphone terminal (not illustrated), a memory card slot (not illustrated), and so forth.

The frame 14 includes frame members 20, 21, and 22. The frame 14 has a shape conforming to three of the side faces 50 of the tablet-personal-computer body 10. The frame member 20 extends along the side face 53 of the tablet-personal-computer body 10. The frame member 21 extends along the side face 52. The frame member 22 extends along the side face 51.

The frame 14 is rotatably attached to two of the side faces 50 of the tablet-personal-computer body 10 with the aid of the hinges 30. An end 22a of the frame member 22 that is farther from the frame member 21 is rotatably attached, with the aid of one of the hinges 30, to an end 51a of the side face 51 of the tablet-personal-computer body 10 that is nearer to the side face 59. An end 20a of the frame member 20 that is farther from the frame member 21 is rotatably attached, with the aid of the other hinge 30, to an end 53a of the side face 53 of the tablet-personal-computer body 10 that is nearer to the side face 59.

The frame 14 is rotatable about the hinges 30 with respect to the tablet-personal-computer body 10 toward both a side having the front face 19a (see FIG. 2) and a side having the rear face 19b (see FIG. 4). The frame 14 is rotatable about the hinges 30 by 360 degrees with respect to the tablet-personal-computer body 10. The hinges 30 are free stop hinges (friction hinges). Therefore, the frame 14 is stoppable at any angle with respect to the tablet-personal-computer body 10.

The frame member 22 of the frame 14 has a slit 26 provided near an end 22b thereof that is nearer to the frame member 21. The frame member 20 has a slit 23 provided near an end 20b thereof that is nearer to the frame member 21. The frame member 21 has slits 24 and 25.

The side face 51 of the tablet-personal-computer body 10 has a projection 57 provided near an end 51b thereof that is nearer to the side face 52. The projection 57 is provided in correspondence with the slit 26. The side face 53 of the tablet-personal-computer body 10 has a projection 54 (see FIG. 21) provided near an end 53b thereof that is nearer to the side face 52. The projection 54 is provided in correspondence with the slit 23. The side face 52 of the tablet-personal-computer body 10 has projections 55 and 56. The projections 55 and 56 are provided in correspondence with the slits 24 and 25, respectively.

If the frame 14 is rotated about the hinges 30 with respect to the tablet-personal-computer body 10 such that the projection 57 is fitted into the slit 26, the projection 54 is fitted into the slit 23, and the projections 55 and 56 are fitted into the respective slits 24 and 25, the frame 14 is fitted around the side faces 50 of the tablet-personal-computer body 10 with the aid of a combination of the projections 57, 54, 55, and 56 and the slits 26, 23, 24, and 25 (see FIG. 1). If the frame 14 is rotated about the hinges 30 with respect to the tablet-personal-computer body 10 such that the projection 57 is disengaged from the slit 26, the projection 54 is disengaged from the slit 23, and the projections 55 and 56 are disengaged from the respective slits 24 and 25 (see FIGS. 2 to 4), the frame 14 is disengaged from the side faces 50 of the tablet-personal-computer body 10. That is, the slits 23, 24, 25, and 26 and the projections 54, 55, 56, and 57 in combination allow the frame 14 to be disengageably fitted around the side faces 50 of the tablet-personal-computer body 10. The slits 23, 24, 25, and 26 functions as first fitting portions and are exemplary fitting portions. The projections 54, 55, 56, and 57 functions as second fitting portions and are exemplary fitted portions.

FIG. 5 illustrates a state where the projections 54, 55, 56, and 57 have been disengaged from the slits 23, 24, 25, and 26, and the frame 14 has been rotated about the hinges 30. Since the hinges 30 are free stop hinges, the frame 14 is stoppable at any angle with respect to the tablet-personal-computer body 10. Therefore, the frame 14 functions as a supporting member that allows the tablet-personal-computer body 10 to stand.

The frame 14 is attached to the side faces 50 of the tablet-personal-computer body 10 with the aid of the hinges 30 provided at the respective ends 20a and 22a of the frame 14. Hence, when the frame 14 is rotated about the hinges 30, the ends 20a and 22a of the frame 14 are allowed to project from the tablet-personal-computer body 10 on a side having a display 17 and do not hinder the operation performed on the tablet-personal-computer body 10 by an operator.

Referring to FIG. 1, the frame 14 is fitted around the side faces 50 of the tablet-personal-computer body 10 by rotating the frame 14 about the hinges 30 such that the projections 57, 54, 55, and 56 are fitted into the respective slits 26, 23, 24, and 25. Thus, the side faces 50 of the tablet-personal-computer body 10 are covered with the frame 14 and the frame 14 functions as a decorative member that decorates the side faces 50.

Referring to FIG. 6, in the tablet-personal-computer body 10, a liquid crystal display unit 16 is held between a front cover 18 and a rear cover 12. The front cover 18 has an opening 18a, from which the display 17 of the liquid crystal display unit 16 is exposed. The hinges 30 to which the frame 14 is fitted are attached to the rear cover 12 with screws 36. The hinges 30 may alternatively be attached to the front cover 18 with screws. A motherboard (not illustrated), a battery (not illustrated), and so forth are provided between the liquid crystal display unit 16 and the rear cover 12. The motherboard includes a central processing unit (CPU, not illustrated), a memory (not illustrated), and so forth. The tablet-personal-computer body 10 functions as a personal computer on its own.

Referring to FIGS. 6 to 8, the hinges 30 each include a shaft 32, a tube 31 provided around the shaft 32, and a securing member 34 attached to the tube 31. The securing member 34 has holes 35. The rear cover 12 has screw receiving members 37. The screw receiving members 37 each have a thread 38 in the inner surface thereof. The securing member 34 is attached to the screw receiving members 37 with the screws 36, whereby the hinge 30 is attached to the rear cover 12.

Referring to FIGS. 6 and 9, an end 32a of the shaft 32 of each of the hinges 30 is fitted in a semicircular notch 41 provided in a corresponding one of side faces 40 of the rear cover 12 and a semicircular notch 43 provided in a corresponding one of side faces 42 of the front cover 18. The end 32a is flush with the side face 40 of the rear cover 12 and the side faces 42 of the front cover 18.

Referring to FIG. 9, the shaft 32 has a recess 91 having a square cross-sectional shape. The end 20a of the frame member 20 has a hole 39 having a hexagonal cross-sectional shape. A stopping member 94 includes a disc-shaped base 33, a projecting portion 93 having a hexagonal cross-sectional shape and provided on the base 33, and a projecting portion 92 having a square cross-sectional shape and provided on the projecting portion 93. The projecting portion 93 is fitted into the hole 39, and the projecting portion 92 is fitted into the recess 91, whereby the frame member 20 is secured to the shaft 32 of the hinge 30 in such a manner as to rotate together with the shaft 32 of the hinge 30. The fitting is performed by, for example, a press-fitting method. The end 22a of the frame member 22 (see FIG. 6) is secured to the shaft 32 of the other hinge 30 in the same manner as the end 20a of the frame member 20 secured to the shaft 32 of the hinge 30.

Referring to FIGS. 10 to 12, a base unit 60 to which the tablet-personal-computer body 10 is attachable includes a front face 70a, a rear face 73a that is opposite the front face 70a, and side faces 61. The front face 70a and the rear face 73a are parallel to each other. The front face 70a includes a front cover 70, a keyboard 71, a touch pad 72, and so forth. The rear face 73a includes a rear cover 73. The side faces 61 include four side faces 62, 63, 64, and 69. The side face 62 and the side face 64 are parallel to each other. The side face 63 and the side face 69 are parallel to each other. The side faces 62 and 64 are perpendicular to the side faces 63 and 69. The side faces 61 are provided with external interface connectors (not illustrated) for USBs, a local area network (LAN), and the like, a power supply connector (not illustrated), and so forth. The base unit 60 is an exemplary expansion device.

The side face 62 of the base unit 60 has a projection 65 provided near an end 62b thereof that is nearer to the side face 63. The side face 64 of the base unit 60 has a projection 68 provided near an end 64b thereof that is nearer to the side face 63. The side face 63 of the base unit 60 has projections 66 and 67. If the tablet-personal-computer body 10 is mounted on the base unit 60 with the display 17 thereof facing the base unit 60 (see FIGS. 21 and 22), the projection 65 faces the slit 23 of the frame 14, the projection 68 faces the slit 26 of the frame 14, and the projections 66 and 67 face the respective slits 24 and 25 of the frame 14. If the tablet-personal-computer body 10 is mounted on the base unit 60 with the display 17 thereof facing away from the base unit 60 (see FIG. 24), the projection 65 faces the slit 26 of the frame 14, the projection 68 faces the slit 23 of the frame 14, and the projections 66 and 67 face the respective slits 25 and 24 of the frame 14.

An end 62a of the side face 62 of the base unit 60 that is nearer to the side face 69 is provided with a fitting member 80 projecting from the front face 70a of the base unit 60. An end 64a of the side face 64 of the base unit 60 that is nearer to the side face 69 is provided with a fitting member 81 projecting from the front face 70a of the base unit 60. The fitting member 81 is fixed to the side face 64 of the base unit 60.

Referring to FIGS. 13 to 16, the fitting member 80 includes a fitting member body 84, guiding portions 87 that guide the movement of the fitting member body 84, and a spring 90. The fitting member body 84 includes a fitting portion 86, an inserted portion 85, and a spring hook 88. The fitting portion 86 is provided at one end of the inserted portion 85. The end 62a of the side face 62 has through holes 62b and 62c extending through the side face 62. The through hole 62c is provided above a central portion of the through hole 62b and is continuous with the through hole 62b. The through hole 62c allows the spring hook 88 to pass there through in an assembly process. The guiding portions 87 are provided on the rear cover 73.

The inserted portion 85 is inserted into the through hole 62b and between the guiding portions 87 and is movable while being guided by the guiding portions 87. The fitting portion 86 is larger than the through hole 62b. Therefore, when the fitting portion 86 comes into contact with the side face 62, the inserted portion 85 is stopped. The rear cover 73 has a spring hook 91. One end of the spring 90 is hooked on the spring hook 91. The other end of the spring 90 is hooked on the spring hook 88 provided on the fitting member body 84. The fitting portion 86 is pulled toward the side face 62 of the base unit 60 by the spring 90, thereby being in contact with the side face 62.

A method of attaching the tablet personal computer 1, in which the frame 14 is attached to the side faces 50 of the tablet-personal-computer body 10, to the base unit 60 will now be described.

Referring to FIGS. 17 to 19, the fitting member 80 has a hole 83 having a circular cross-sectional shape. The fitting member 81 has a hole 82 having a circular cross-sectional shape. When the fitting member 80 is moved by a finger or the like, the fitting member 80 is detached from the side face 62 of the base unit 60 (see FIG. 14). In this state, the disc-shaped base 33 (see FIGS. 7 to 9) of a corresponding one of the stopping members 94 with which the frame 14 is attached to the hinges 30, is fitted into the hole 82 of the fitting member 81. Furthermore, while the disc-shaped base 33 of the other one of the stopping members 94 with which the frame 14 is attached to the hinges 30 is positioned at the hole 83 of the fitting member 80, the finger or the like is taken off the fitting member 80. Thus, the fitting member 80 is pulled toward the side face 62 by the spring 90 (see FIGS. 15 and 16), and the disc-shaped base 33 of the stopping member 94 (see FIGS. 7 to 9) is fitted into the hole 83 of the fitting member 80.

In this manner, the disc-shaped bases 33 of the stopping members 94 are fitted into the hole 83, having a circular cross-sectional shape, of the fitting member 80 and the hole 82, having a circular cross-sectional shape, of the fitting member 81, respectively. Therefore, while the hinges 30 are secured to the base unit 60, the frame 14 and the tablet-personal-computer body 10 are each rotatable about the hinges 30. The fitting member 80 is movable in a direction away from the side face 62. Furthermore, the fitting member 80 is pulled toward the side face 62 by the spring 90, thereby being in contact with the side face 62. Thus, the tablet personal computer 1 including the tablet-personal-computer body 10 to which the frame 14 is attached is detachably held by the base unit 60 with the aid of the fitting members 80 and 82.

In this state, the frame 14 is fitted around the side faces 50 of the tablet-personal-computer body 10 (see FIG. 20). When the frame 14 in this state is pressed down in such a manner as to be rotated about the hinges 30 downward with respect to the tablet-personal-computer body 10, the projection 54 of the tablet-personal-computer body 10 is disengaged from the slit 23 of the frame 14, the projection 57 is disengaged from the slit 26, and the projections 55 and 56 are disengaged from the respective slits 24 and 25. When the frame 14 is further pressed down in such a manner as to be rotated about the hinges 30 downward with respect to the tablet-personal-computer body 10 (see FIGS. 21 and 22), the projection 65 of the base unit 60 is fitted into the slit 23 of the frame 14, the projection 68 is fitted into the slit 26 of the frame 14, and the projections 66 and 67 are fitted into the respective slits 24 and 25 of the frame 14. Thus, the frame 14 is fitted around the side faces 61 of the base unit 60 (see FIGS. 21 and 22). That is, the base unit 60 is fitted into the frame 14, thereby being attached to the tablet-personal-computer body 10.

In this manner, the fitting members 80 and 81 allow the tablet-personal-computer body 10 to be attached to the base unit 60 such that the tablet-personal-computer body 10 is rotatable about the hinges 30, and the projections 65 to 68 and the slits 23 to 26 allow the frame 14 to be fitted around the base unit 60. Thus, the tablet-personal-computer body 10 is attached to the base unit 60 in such a manner as to be rotatable about the hinges 30. The fitting members 80 and 81 are exemplary holding portions. The projections 65 to 68 are exemplary third fitting portions.

To detach the tablet-personal-computer body 10 from the base unit 60, the frame 14 is pushed up in such a manner as to be rotated about the hinges 30 upward with respect to the tablet-personal-computer body 10 (see FIG. 20). Thus, the projection 65 of the base unit 60 is disengaged from the slit 23 of the frame 14, the projection 68 is disengaged from the slit 26 of the frame 14, and the projections 66 and 67 are disengaged from the respective slits 24 and 25 of the frame 14.

In this state, the fitting member 80 is moved in the direction away from the side face 62 of the base unit 60, whereby the disc-shaped base 33 of a corresponding one of the stopping members 94 (see FIGS. 7 to 9) comes out of the hole 83 of the fitting member 80 (see FIG. 19). Subsequently, the tablet-personal-computer body 10 is moved toward the fitting member 80, whereby the disc-shaped base 33 of the other stopping member 94 (see FIGS. 7 to 9) comes out of the hole 82 of the fitting member 81 (see FIG. 18). Thus, the tablet-personal-computer body 10 is detached from the base unit 60.

As described above, if the projections 65, 68, 66, and 67 on the side faces 61 of the base unit 60 are fitted into the respective slits 23, 26, 24, and 25 of the frame 14, the frame 14 is fitted around the side faces 61 of the base unit 60. If the projections 65, 68, 66, and 67 on the side faces 61 of the base unit 60 are disengaged from the respective slits 23, 26, 24, and 25 of the frame 14, the frame 14 is disengaged from the side faces 61 of the base unit 60. In this manner, the slits 23, 24, 25, and 26 of the frame 14 and the projections 54, 55, 56, and 57 on the side faces 61 of the base unit 60 in combination allow the frame 14 to be disengageably fitted around the side faces 61 of the base unit 60.

Referring to FIG. 23, if the tablet-personal-computer body 10 attached to the base unit 60 is rotated about the hinges 30, the display 17 provided on the front face 19a of the tablet-personal-computer body 10 and the components such as the keyboard 71 and the touch pad 72 provided on the front face 70a of the base unit 60 are exposed. Since the hinges 30 are free stop hinges, the tablet-personal-computer body 10 is stoppable at any angle with respect to the base unit 60. In this state, sentences and so forth are easily inputtable into the tablet-personal-computer body 10 by using the components such as the keyboard 71 and the touch pad 72.

The frame 14 is attached to the end 51a and the end 53a of the side faces 50 of the tablet-personal-computer body 10 with the aid of the hinges 30. Hence, while the base unit 60 is laid horizontally, the tablet-personal-computer body 10 attached to the base unit 60 is rotatable about the hinges 30. Thus, the entire surface of the display 17 on the front face 19a of the tablet-personal-computer body 10 is exposed above the base unit 60.

FIG. 24 illustrates a state where the tablet personal computer 1 in which the frame 14 is attached to the side faces 50 of the tablet-personal-computer body 10 is attached to the base unit 60 with the display 17 thereof facing away from the base unit 60 (with the display 17 facing upward). In this state, while the tablet-personal-computer body 10 is attached to the base unit 60, the display 17 is easily observable not only by the operator who operates the tablet personal computer 1 but also by persons other than the operator.

A method of attaching the tablet personal computer 1 to the base unit 60 with the display 17 facing upward is the same as in the case where the display 17 faces downward, except that the projections 65, 68, 66, and 67 on the base unit 60 face the slits 26, 23, 25, and 24, respectively, of the frame 14.

The tablet-personal-computer body 10 operates with an operation system (OS) such as Android (a registered trademark) that is employed in mobile terminals and the like. The tablet-personal-computer body 10 that is attached to the base unit 60 also operates with an OS such as Android (a registered trademark) that is employed in mobile terminals and the like.

The base unit 60 may include a motherboard (not illustrated) including a CPU (not illustrated), a memory (not illustrated), and so forth, a battery (not illustrated), and other components, so that the base unit 60 functions as a personal computer that operates with Windows (a registered trademark). In such a case, if the tablet-personal-computer body 10 is used alone, the tablet-personal-computer body 10 operates with an OS such as Android (a registered trademark) that is employed in mobile terminals and the like. If the tablet-personal-computer body 10 is attached to the base unit 60, the tablet-personal-computer body 10 operates with Windows (a registered trademark).

No cable connection is provided between the tablet-personal-computer body 10 and the base unit 60. The tablet-personal-computer body 10 and the base unit 60 are each capable of wireless data transfer and being powered in a noncontact manner.

Referring to FIG. 25, a first modification of the mechanism of attaching the frame 14 to the tablet-personal-computer body 10 will now be described. In the above embodiment, the projecting portion 92 included in each stopping member 94 and having a square cross-sectional shape is fitted into the recess 91 provided in the shaft 32 and having a square cross-sectional shape, and the projecting portion 93 included in the stopping member 94 and having a hexagonal cross-sectional shape is fitted into the hole 39 provided in the frame member 20 and having a hexagonal cross-sectional shape (see FIG. 9). The first modification is the same as the above embodiment except that a hole 97 provided in the frame member 20 and having a hexagonal cross-sectional shape is fitted onto a projecting portion 95 provided at the end 32a of the shaft 32 of the hinge 30 and having a hexagonal cross-sectional shape.

More specifically, the projecting portion 95 having a hexagonal cross-sectional shape is provided at the end 32a of the shaft 32 of the hinge 30. A disc-shaped base 33 having the same shape as the disc-shaped base 33 (see FIGS. 7 to 9) of the stopping member 94 according to the above embodiment is provided on a side of the projecting portion 95 that is farther from the shaft 32. The shaft 32, the projecting portion 95, and the disc-shaped base 33 are coaxial with one another. The shaft 32 and the disc-shaped base 33 each have a larger cross-sectional area than the projecting portion 95. Hence, the peripheral portion of the shaft 32 and the peripheral portion of the disc-shaped base 33 project with respect to the projecting portion 95. The projecting portion 95 has two recesses 96 at one end (a lower one in FIG. 25) thereof. The end 20a of the frame member 20 has the hole 97 having a hexagonal cross-sectional shape. One end 97a (a lower one in FIG. 25) of the hole 97 is open. The open end 97a of the hole 97 has two protrusions 98 protruding toward the inner side of the hole 97. The distance between the end 32a of the shaft 32 and the disc-shaped base 33, that is, the thickness of the projecting portion 95 is substantially the same as the thickness of the frame member 20. The hole 97 of the frame member 20 is fitted onto the projecting portion 95 through the open end 97a, and the protrusions 98 at the open end 97a of the hole 97 are fitted into the respective recesses 96 of the projecting portion 95, whereby the frame member 20 is secured to the shaft 32 of the hinge 30 in such a manner as to rotate together with the shaft 32 of the hinge 30. The end 22a of the frame member 22 (see FIG. 6) is secured to the shaft 32 of the other hinge 30 in the same manner as the end 20a of the frame member 20 secured to the shaft 32 of the hinge 30. To remove the frame member 20 from the shaft 32 of the hinge 30, the above process is performed the other way round. The projecting portion 95 and the hole 97 are exemplary fitting members.

Referring to FIG. 26, a second modification of the mechanism of attaching the frame 14 to the tablet-personal-computer body 10 will now be described. In the above embodiment, the projecting portion 92 of the stopping member 94 that has a square cross-sectional shape is fitted into the recess 91 provided in the shaft 32 and having a square cross-sectional shape, and the projecting portion 93 included in the stopping member 94 and having a hexagonal cross-sectional shape is fitted into the hole 39 provided in the frame member 20 and having a hexagonal cross-sectional shape (see FIG. 9). In the second modification, a projecting portion 101 provided at the end 32a of the shaft 32 of the hinge 30 and having a hexagonal cross-sectional shape is fitted into a hole 103 provided in the frame member 20 and having a hexagonal cross-sectional shape.

More specifically, the projecting portion 101 having a hexagonal cross-sectional shape is provided at the end 32a of the shaft 32 of the hinge 30. The projecting portion 101 has a thread 102 in the inner surface thereof. A stopping member 104 includes a disc-shaped base 33 and a screw 105 provided on the disc-shaped base 33. The hole 103 having a hexagonal cross-sectional shape is provided at the end 20a of the frame member 20. The projecting portion 101 is fitted into the hole 103, and the screw 105 is screwed into the projecting portion 101 along the thread 102, whereby the frame member 20 is secured to the shaft 32 of the hinge 30 in such a manner as to rotate together with the shaft 32 of the hinge 30. The end 22a of the frame member 22 (see FIG. 6) is secured to the shaft 32 of the other hinge 30 in the same manner as the end 20a of the frame member 20 secured to the shaft 32 of the hinge 30. To remove the frame member 20 from the shaft 32 of the hinge 30, the above process is performed the other way round. The other details of the second modification are the same as those of the above embodiment. The projecting portion 101 and the stopping member 104 are exemplary fitting members.

Referring to FIGS. 27 to 29, a third modification concerning the tablet-personal-computer body 10, the frame 14, and the base unit 60 will now be described. In the above embodiment, the frame 14 has the slits 23 to 26, the tablet-personal-computer body 10 has the projections 54 to 57, and the base unit 60 has the projections 65 to 68. Furthermore, the slits 23 to 26 and the projections 54 to 57 in combination allow the frame 14 to be disengageably fitted around the tablet-personal-computer body 10. Furthermore, the slits 23 to 26 and the projections 65 to 68 in combination allow the frame 14 to be disengageably fitted around the base unit 60. In the third modification, the frame 14 has projections 23a to 26a, the tablet-personal-computer body 10 has slits 54a to 57a, and the base unit 60 has slits 65a, 66a, and others. The slits 54a to 57a and the projections 23a to 26a in combination allow the frame 14 to be disengageably fitted around the tablet-personal-computer body 10. The slits 65a, 66a, and others and the projections 23a, 24a, and others in combination allow the frame 14 to be disengageably fitted around the base unit 60. The other details of the third modification are the same as those of the above embodiment. The projections 23a to 26a function as first fitting portions and are exemplary fitting portions. The slits 54a to 57a function as second fitting portions and are exemplary fitted portions. The slits 65a and 66a function as exemplary third fitting portions.

As described above, the frame 14 having a shape conforming to the side faces 50 of the tablet-personal-computer body 10 is rotatably attached to the side faces 50 with the aid of the hinges 30. Since the hinges 30 are free stop hinges, the frame 14 is stoppable at any angle with respect to the tablet-personal-computer body 10. Hence, the frame 14 also functions as a supporting member that allows the tablet-personal-computer body 10 to stand. Since the frame 14 has a shape conforming to the side faces 50 of the tablet-personal-computer body 10, the frame 14 is fittable around the side faces 50. Hence, the frame 14 does not hinder the use of the tablet-personal-computer body 10 as a stand-alone tablet personal computer. Moreover, when the side faces 50 of the tablet-personal-computer body 10 is covered with the frame 14, the frame 14 functions as a decorative member that decorates the side faces 50. Furthermore, the ends 20a and 22a of the frame 14 are attached to the side faces 50 of the tablet-personal-computer body 10 with the aid of the hinges 30. Hence, when the frame 14 is rotated about the hinges 30, the ends 20a and 22a of the frame 14 are allowed to project from the tablet-personal-computer body 10 on a side having the display 17 and do not hinder the operation performed on the tablet-personal-computer body 10.

The frame 14 also functions as a securing member with which the tablet-personal-computer body 10 is secured to the base unit 60. In a case where the tablet-personal-computer body 10 has been attached to the base unit 60, since the hinges 30 are free stop hinges, the tablet-personal-computer body 10 is stoppable at any angle with respect to the base unit 60. That is, the tablet-personal-computer body 10 is orientable at any desired angle with respect to the base unit 60 by rotating the tablet-personal-computer body 10 about the hinges 30. Consequently, the display 17 of the tablet-personal-computer body 10 is orientable at any desired angle with respect to the base unit 60. Furthermore, sentences and so forth are easily inputtable into the tablet-personal-computer body 10 by using the components such as the keyboard 71 and the touch pad 72 included in the base unit 60. Moreover, the frame 14 is attached to the end 51a and the end 53a of the side faces 50 of the tablet-personal-computer body 10 with the aid of the respective hinges 30. Hence, while the base unit 60 is laid horizontally, the tablet-personal-computer body 10 that is attached to the base unit 60 is rotatable about the hinges 30. Thus, the entire surface of the display 17 of the tablet-personal-computer body 10 is exposed on the base unit 60.

With the frame 14 provided to the tablet-personal-computer body 10, the handleability, the convenience, and the decorativeness of the tablet personal computer 1 are improved. Moreover, the frame 14 also functions as a supporting member that allows the tablet-personal-computer body 10 to stand, and as a securing member with which the tablet-personal-computer body 10 is secured to the base unit 60. Thus, by employing the frame 14 that also functions as a supporting member and a securing member, the number of components is reduced, and a low-cost apparatus is realized.

The frame 14 has the slits 26, 23, 24, and 25, and the side faces 50 of the tablet-personal-computer body 10 have the projections 57, 54, 55, and 56 in correspondence with the slits 26, 23, 24, and 25, respectively. Hence, the slits 26, 23, 24, and 25 and the projections 57, 54, 55, and 56 in combination allow the frame 14 to be disengageably fitted around the side faces 50 of the tablet-personal-computer body 10. Furthermore, the side faces 61 of the base unit 60 has the projections 65, 68, 66, and 67 in correspondence with the slits 23, 26, 24, and 25, respectively, of the frame 14. Hence, the slits 26, 23, 24, and 25 and the projections 57, 54, 55, and 56 in combination allow the frame 14 to be disengageably fitted around the side faces 61 of the base unit 60. Alternatively, as in the third modification, the frame 14 may have projections 23a to 26a, the tablet-personal-computer body 10 may have slits 54a to 57a, and the base unit 60 may have slits 65a, 66a, and others (see FIGS. 27 to 29). In such a case, the slits 54a to 57a and the projections 23a to 26a in combination allow the frame 14 to be disengageably fitted around the tablet-personal-computer body 10, and the slits 65a, 66a, and others and the projections 23a, 24a, and others in combination allow the frame 14 to be disengageably fitted around the base unit 60.

The fitting members 80 and 81 allow the tablet-personal-computer body 10 to which the frame 14 is attached to be attached to the base unit 60 in such a manner as to be rotatable about the hinges 30. Hence, the frame 14 and the tablet-personal-computer body 10 are each rotatable about the hinges 30 with the hinges 30 secured to the base unit 60. Moreover, the fitting members 80 and 81 allow the tablet personal computer 1 including the tablet-personal-computer body 10 to which the frame 14 is attached to be detachably held by the base unit 60.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing apparatus comprising:
a body;
a frame; and
a hinge that allows the frame to be attached to a side face of the body in such a manner as to be rotatable and stoppable at any angle.

2. The information processing apparatus according to claim 1, further comprising:
a first fitting portion provided on the frame; and
a second fitting portion provided on the side face and that allows, in combination with the first fitting portion, the frame to be disengageably fitted along the side face.

3. An information processing apparatus comprising:
a body; and
a hinge that allows a frame to be attached to a side face of the body rotatably and stoppably at any angle.

4. The information processing apparatus according to claim 3, further comprising:
a second fitting portion provided on the side face and that allows, in combination with a first fitting portion provided on the frame, the frame to be disengageably fitted along the side face.

5. The information processing apparatus according to claim 1, wherein the hinge allows an end of the frame to be attached to the side face.

6. The information processing apparatus according to claim 1, wherein the hinge is provided at an end of the side face.

7. The information processing apparatus according to claim 1, wherein the hinge is a free stop hinge.

8. The information processing apparatus according to claim 2,
wherein the first fitting portion is one of a slit and a projection, and
wherein the second fitting portion is the other of the slit and the projection.

9. An electronic apparatus comprising:
an information processing apparatus including
a body,
a frame,
a hinge that allows the frame to be attached to a side face of the body rotatably and stoppably at any angle,
a first fitting portion provided on the frame, and
a second fitting portion provided on the side face and that allows, in combination with the first fitting portion, the frame to be disengageably fitted along the side face; and
an expansion device including a third fitting portion that allows, in combination with the first fitting portion, the frame to be disengageably fitted to the expansion device, the expansion device being attached to the information processing apparatus by being fitted into the frame.

10. The electronic apparatus according to claim 9,
wherein the first fitting portion is one of a slit and a projection, and
wherein the third fitting portion is the other of the slit and the projection.

11. The electronic apparatus according to claim 9, wherein the expansion device further includes a holding portion that holds the information processing apparatus such that the information processing apparatus is rotatable about the hinge.

12. The electronic apparatus according to claim 9, wherein the holding portion allows the information processing apparatus to be detachably held by the expansion device.
